(19) United States
(12) Patent Application Publication
(10) Pub. No.: US 2010/0309284 A1
(43) Pub. Date: Dec. 9, 2010

(54) Systems and methods for dynamically displaying participant activity during video conferencing

(76) Inventors: Ramin Samadani, Palo Alto, CA (US); Ian N. Robinson, Pebble Beach, CA (US); Ton Kalker, Carmel, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/455,624

(22) Filed: Jun. 4, 2009

(51) Int. Cl. H04N 7/15

(52) U.S. Cl. 348/14.08; 348/E07.083

(57) ABSTRACT

Various aspects of the present invention are directed to systems and methods for highlighting participant activities in video conferencing. In one aspect, a method of generating a dynamic visual representation of participants taking part in a video conference comprises rendering an audio-visual representation of the one or more participants at each site taking part in the video conference using a computing device. The method includes receiving a saliency signal using the computing device, the saliency signal identifying the degree of current and/or recent activity of the one or more participants at each site. Based on the saliency signal associated with each site, the method applies image processing to elicit visual popout of active participants associated each site, while maintaining fixed scale and borders interface of the visual representation of the one or more participants at each site.

### TECHNICAL FIELD

Embodiments of the present invention relate to video conferencing methods and systems.

### BACKGROUND

Video conferencing enables participants located at two or more sites to simultaneously interact via two-way video and audio transmissions. A video conference can be as simple as a conversation between two participants in private offices (point-to-point) or involve a number of participants at different sites (multi-point) with one or more participants located at each site. In recent years, high-speed network connectivity has become more widely available at a reasonable cost and the cost of video capture and display technologies has decreased. As a result, expending time and money in travelling for meetings continues to decrease as video conferencing conducted over networks between participants in far away places becomes increasing more popular.

In a typical multi-point video conferencing experience, each site includes a display screen that projects the video stream supplied from each site in a corresponding window. However, the connectivity improvements mentioned above make it possible for a video conference to involve a large number of sites. As a result, the display screen at each site can become crowded with windows and the size of each window may be reduced so that all of the windows can fit within the display screen boundaries. Crowded display screens with many windows can create a distracting and disorienting video conferencing experience for participants, because participants have to carefully visually scan the individual windows in order to determine which participants are speaking. Thus, video conferencing systems that effectively identify participants speaking at the different sites are desired.

### BRIEF DESCRIPTION OF THE DRAWINGS

FIG. 1 shows an example of a user interface comprising eight separate windows organized in accordance with embodiments of the present invention.

FIG. 2 shows an example of a video conferencing system for sending video and audio signals over a network in accordance with embodiments of the present invention.

FIG. 3 shows an example of a video conferencing system for sending video and audio signals over a network in accordance with embodiments of the present invention.

FIG. 4 shows a schematic representation of a computing device configured in accordance with embodiments of the present invention.

FIG. 5 shows an example of visual popout.

FIGS. 6A-6E show examples of ways in which a user interface can be used in video conferencing in accordance with embodiments of the present invention.

FIGS. 7A-7B show two examples of window layouts for video conferencing in accordance with embodiments of the present invention.

FIG. 8 shows a control-flow diagram of operations performed by a computing device and server in conducting a video conference in accordance with embodiments of the present invention.

FIG. 9 shows a control-flow diagram of operations performed by a computing device and moderator in conducting a video conference in accordance with embodiments of the present invention.

### DETAILED DESCRIPTION

Various embodiments of the present invention are directed to systems and methods for highlighting participant activities in video conferencing. Participants taking part in a video conference are displayed in separate windows of a user interface that is displayed at each participant site. Embodiments of the present invention process audio and/or visual activities of the participants in order to determine which participants are actively participating in the video conference, such as speaking. Visual popout is the basis for highlighting windows displaying active participants so that other participants can effortlessly identify the active participants.

### I. Video Conferencing

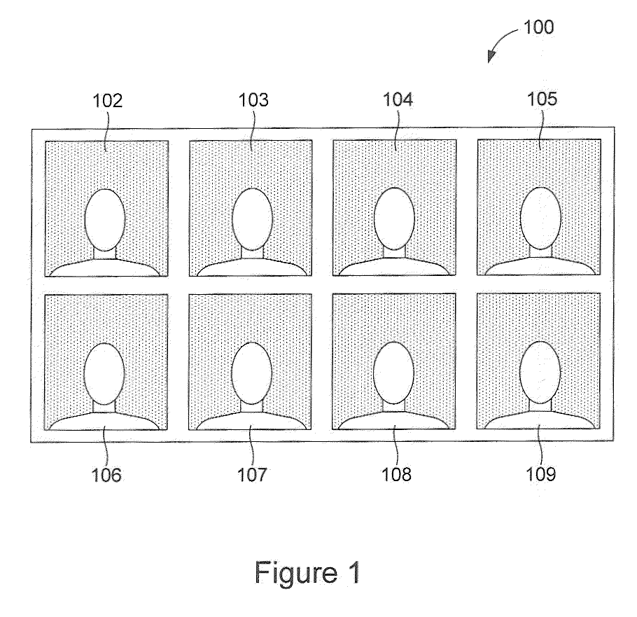

FIG. 1 shows an example of a user interface 100 comprising eight separate windows 102-109 organized in accordance with embodiments of the present invention. In practice, each window 102-109 is a visual representation that actually displays one or more participants located at a site, but for the sake of simplicity, each window 102-109 displays one of eight participants, each participant located at a different site and taking part in a video conference. The user interface 100 may represent a portion of an interactive graphic user interface that appears on a display, such as computer monitor or television set, of a computing device at the site of each participant so that each participant can simultaneously view the other participants participating in the video conference. Each window 102-109 is a manifestation of a video stream generated and sent from a computing device located at one of the sites. The participants can be located in different rooms of the same building, different buildings, cities, or countries. For example, the participant displayed in window 102 can be located in Hong Kong, China, and the participant displayed in window 109 can be located in Palo Alto, Calif.

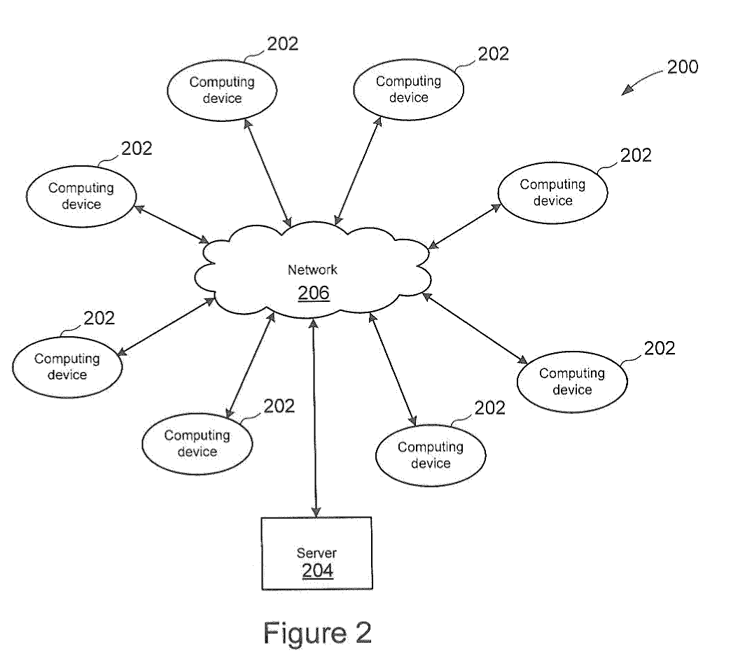

FIG. 2 shows an example of a video conferencing system 200 for transmitting video and audio signals over a network in accordance with embodiments of the present invention. The system 200 includes eight computing devices 202 and a server 204, all of which are in communication over a network 206. In the example shown in FIG. 2, the computing devices 202 can be operated by the participants displayed in the windows 102-109 shown in FIG. 1. The server 204 can be a correlating device that determines which computing devices 202 are participating in the video conference so that the computing devices 202 can send and receive voice and video signals over the network 206. The network 206 can be the Internet, a local-area network, an intranet, a wide-area network, a wireless network, or any other suitable network allowing computing devices to computing devices to send and receive audio and video signals.

A computing device 202 can be any device that enables a video conferencing participant to send and receive audio and video signals and can present a participant with the user interface 100 on a display screen. A computing device 202 can be, but is not limited to: a desktop computer, a laptop computer, a portable computer, a smart phone, a mobile phone, a display system, a television, a computer monitor, a navigation system, a portable media player, a personal digital assistant (“PDA”), a game console, a handheld electronic device, an embedded electronic device or appliance. Each computing device 202 includes one or more ambient audio detectors, such as microphone, for collecting ambient audio and a camera.

In certain embodiments, the computing device 202 can be composed of separate components mounted in a room, such as a conference room. In other words, components of the computing device, such as the display, microphones, and camera, can be placed in suitable locations of the conference room. For example, the computing device 202 can be composed of one or more microphones located on a table within the conference room, the display can be mounted on a conference room wall, and a camera can be disposed on the wall adjacent to the display. The one or more microphones can be operated to continuously collect and transmit the ambient audio generated in the room, and the camera can be operated to continuously capture images of the room and the participants.

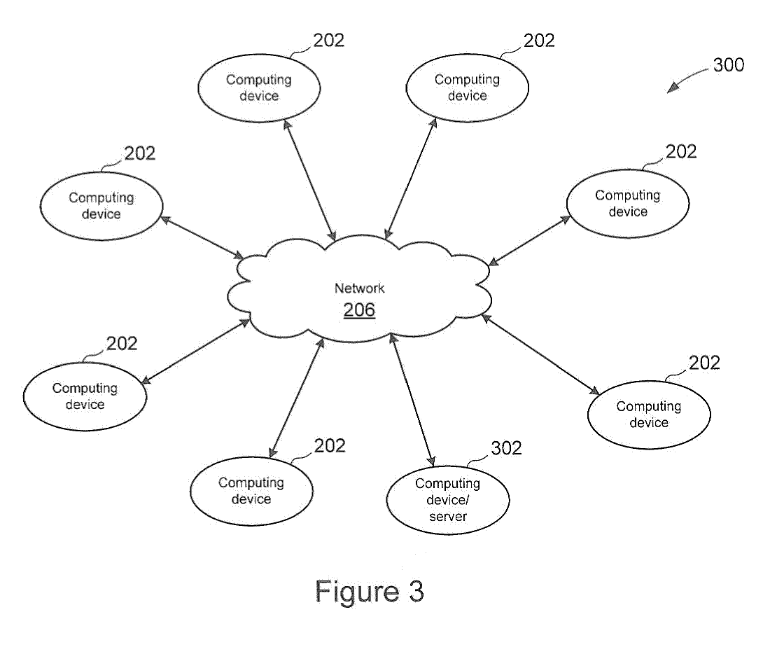

In other embodiments, the operations performed by the server 204 can be performed by one of the computing devices 202 operated by a participant. FIG. 3 shows an example of a video conferencing system 300 for sending video and audio signals over the network 206 in accordance with embodiments of the present invention. The system 300 is nearly identical to the system 200 with the server 204 removed and the same video conference operations performed by the computing device 302.

### II. Computing Devices

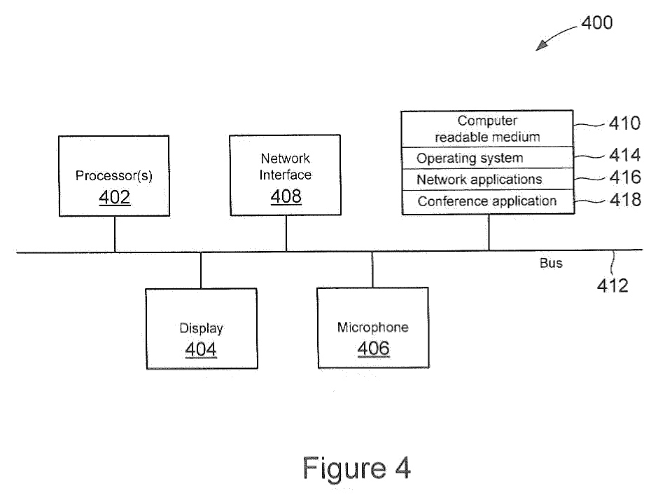

FIG. 4 shows a schematic representation of a computing device 400 configured in accordance with embodiments of the present invention. The device 400 includes one or more processors 402, such as a central processing unit; one or more display devices 404, such as a monitor; a microphone interface 406; one or more network interfaces 408, such as a Local Area Network LAN, a wireless 802.11×LAN, a 3G mobile WAN or a WiMax WAN; and one or more computer-readable mediums 410. Each of these components is operatively coupled to one or more buses 412. For example, the bus 412 can be an EISA, a PCI, a USB, a FireWire, a NuBus, or a PDS.

The computer readable medium 410 can be any suitable medium that participates in providing instructions to the processor 402 for execution. For example, the computer readable medium 410 can be non-volatile media, such as an optical or a magnetic disk; volatile media, such as memory; and transmission media, such as coaxial cables, copper wire, and fiber optics. Transmission media can also take the form of acoustic, light, or radio frequency waves. The computer readable medium 410 can also store other software applications, including word processors, browsers, email, Instant Messaging, media players, and telephony software.

The computer-readable medium 410 may also store an operating system 414, such as Mac OS, MS Windows, Unix, or Linux; a network signals module 416; and a conference application 418. The operating system 414 can be multi-user, multiprocessing, multitasking, multithreading, real-time and the like. The operating system 414 can also perform basic tasks such as recognizing input from input devices, such as a keyboard or a keypad; sending output to the display 404 and microphone 406; keeping track of files and directories on medium 410; controlling peripheral devices, such as disk drives, printers, image capture device; and managing traffic on the one or more buses 412. The network applications 416 includes various components for establishing and maintaining network connections, such as software for implementing communication protocols including TCP/IP, HTTP, Ethernet, USB, and FireWire.

The conference application 418 provides various software components for enabling video conferences, as described below in subsections III-IV. The server 204, shown in FIG. 2, hosts certain conference application functions enabling the server 204 to interact with the computing devices 202 when the conference application is activated as described below. In certain embodiments, some or all of the processes performed by the application 418 can be integrated into the operating system 414. In certain embodiments, the processes can be at least partially implemented in digital electronic circuitry, or in computer hardware, firmware, software, or in any combination thereof.

### III. Video Conferencing Experiences

Visual search tasks are a type of perceptual task in which a viewer searches for target objects in an image that also includes a number of visually distracting objects. Under some conditions, a viewer has to examine the individual objects in an image in order to distinguish the target objects from the distracting objects. As a result, visual search times increase significantly as the number of distracting objects increases. In other words, the efficiency of a visual search depends on the number and type of distracting objects that may be present in the image. On the other hand, under some conditions a visual search task can be performed more efficiently and quickly when the target objects are in some manner highlighted so that the target objects can visually distinguished from the distracting objects. Under these conditions, the visual search tasks search times do not increase significantly as the number of distracting objects increases. This property of identifying distinguishable target objects with relatively faster search times regardless of the number of visually distracting objects is called “visual popout.”

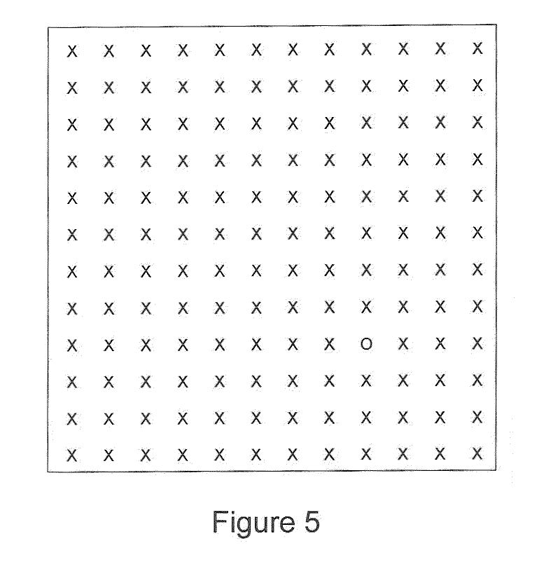

The factors contributing to popout are generally comparable from one viewer to the next, leading to similar viewing experiences for many different viewers. FIG. 5 shows an example of visual popout with a two-dimensional 12×12 grid of 143 “X's” and one “O.” The “O,” located in the lower, right-hand portion of the two-dimensional array of “X's,” strongly pops out to a viewer. As a result, the viewer's attention is nearly effortlessly and immediately drawn to the “O.”

Embodiments of the present invention employ visual popout by highlighting windows associated with active participants or individual active participants, enabling other participants to quickly identify the active participants. In other words, visual popout enables each participant to quickly identify which participants are speaking by simply viewing the user interface as a whole and without having to spend time carefully scanning the individual windows for active participants.

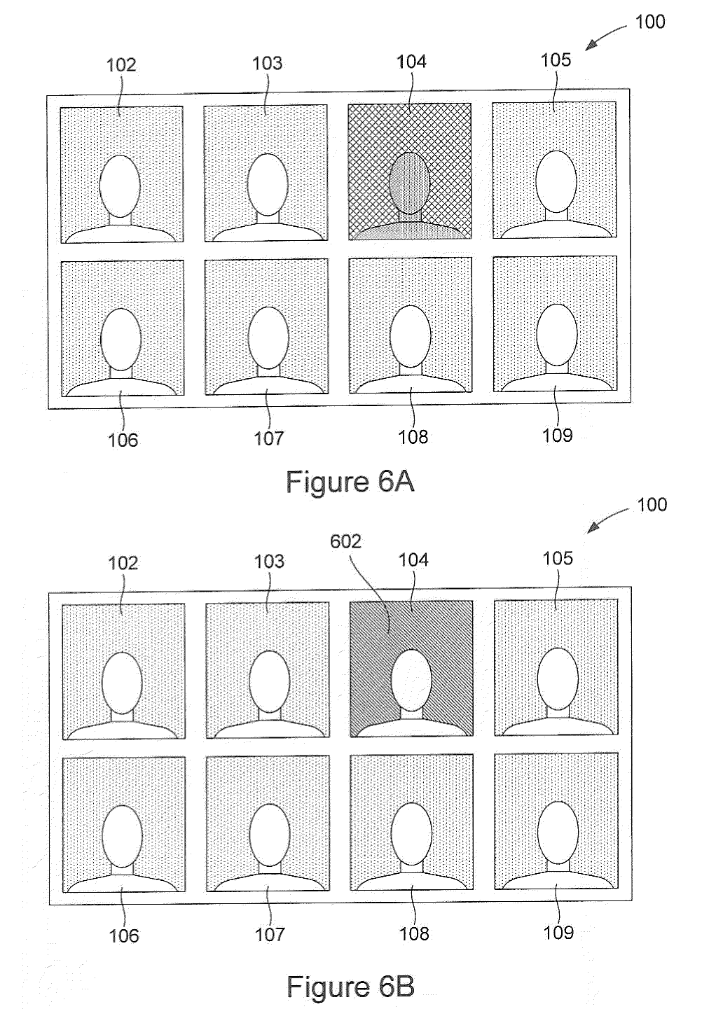

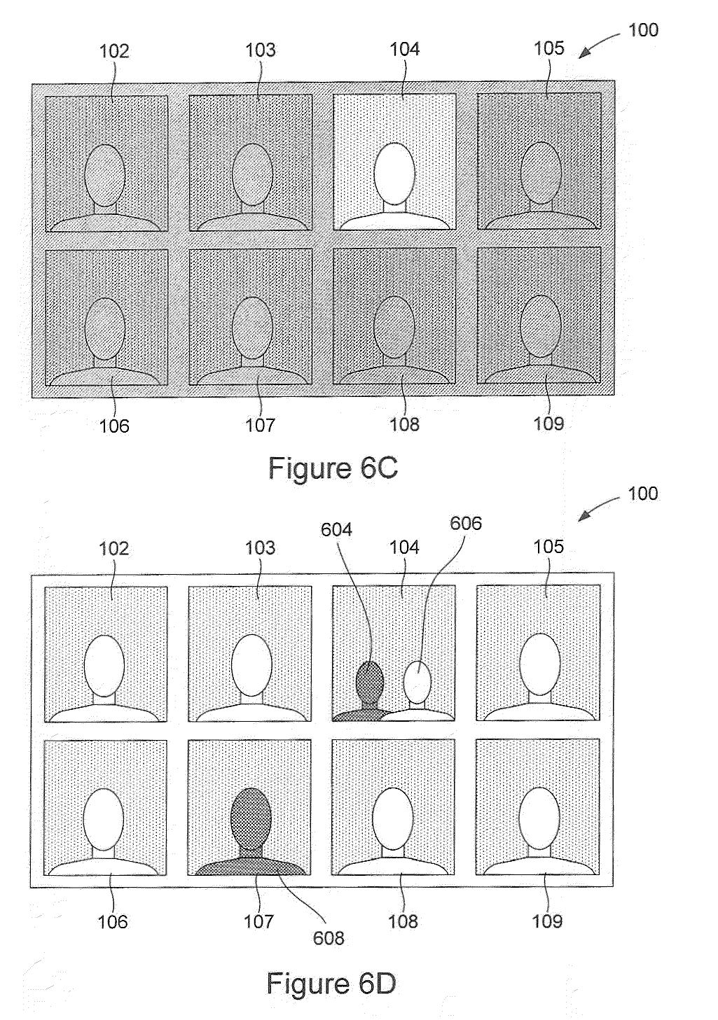

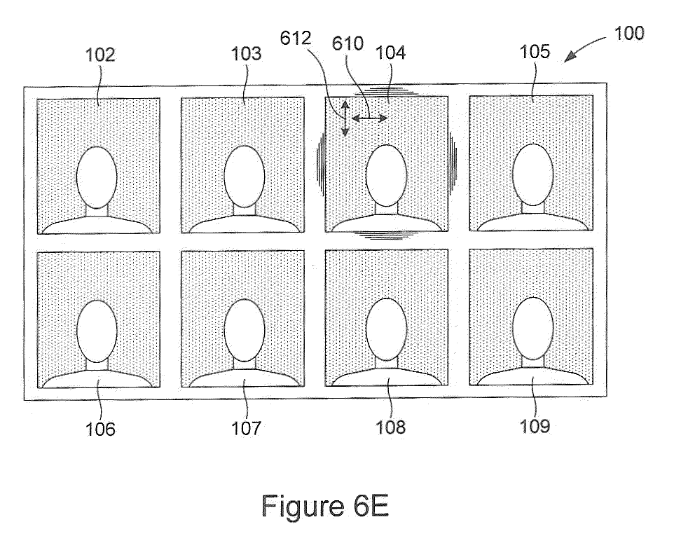

With reference to the example user interface 100 displayed in FIG. 1, FIGS. 6A-6D show examples of ways in which a window associated with a speaking participant can appear to visually popout to the participants taking part in the same video conference in accordance with embodiments of the present invention. In the examples shown in FIGS. 6A-6D, the participant displayed in the window 104 is assumed to be speaking while the other participants displayed in windows 102, 103, and 105-109 are assumed to be listening.

In certain embodiments, popout windows can be created by switching windows from color to grayscale or from grayscale to color. FIG. 6A represents embodiments where the participant displayed in window 104 speaks and the window 104 changes color. Consider an embodiment where the windows 102-109 are displayed as grayscale images when none of the associated participants are speaking. When the participant displayed in window 104 begins to speak, the window 104 switches from a grayscale image to a color image, which is represented in FIG. 6A by a cross-hatched background and dark shading of the participant displayed in window 104. The windows 102, 103, and 105-109 associated with the remaining non-speaking participants stay grayscale. Consider an embodiment where the windows 102-109 are displayed as color images when none of the associated participants are speaking. When the participant displayed in window 104 begins to speak, the window 104 switches from a color image to a grayscale image also represented by the cross-hatched background and dark shading of the participant. In this embodiment, the windows 102, 103, and 105-109 associated with the remaining non-speaking participants stay colored. In either embodiment, the window 104 exhibits visual popout with respect to the windows 102, 103 and 105-109.

In certain embodiments, the images of each participant displayed in the windows 102-109 can be obtained using three-dimensional time-of-flight cameras, which are also called depth cameras. Embodiments of the present invention can include processing the images collected from the depth cameras in order to separate the participants from the backgrounds within each window. The different backgrounds can be processed so that each window has the same background when the participants are not speaking. On the other hand, when a participant begins to speak, the background pattern changes. For example, as shown in FIG. 6B, when the participant displayed in the window 104 begins to speak, the background 602 of the window 104 switches to a hash-marked pattern, which is different from the backgrounds of the windows 102, 103, and 105-109. When background texture differences are appropriately selected, such as background pattern orientations, visual popout of the associated window results.

In certain embodiments, popout windows can be created by a contrast in luminance between windows associated with speaking participants and windows associated with non-speaking participants. When none of the participants are speaking, the luminance of the user interface 100 can be relatively low. FIG. 6C shows an embodiment where the participant displayed in window 104 speaks and the luminance of the window 104 is switched to have a greater luminance than the remaining windows 102, 103, and 105-109. The window 104 pops out as a result of the contrast between the relatively low luminance of the windows 102, 103, and 105-109 and the relatively higher luminance of the window 104.

In certain embodiments, rather the highlighting the window associated with a speaking participant, the speaking participant within the window can instead be highlighted. In other words, embodiments of the present invention include highlighting individual speaking participants within the respective window rather than highlighting the entire window displaying a speaking participant. FIG. 6D shows an embodiment where individual participants engaged in speaking are highlighted. For example, window 104 shows two participants 604 and 606. The participant 604 is speaking and is highlighted in order to distinguish the participant 604 from the non-speaking participant 606 within the same window 104. In addition, a participant 608 in window 107 is highlighted indicating that the participant 608 is also speaking. The individual speaking participants can be made to visually popout by switching the image of the participant from color to grayscale or from grayscale to color, as described above with reference to FIG. 6A, or by creating a contrast in luminance so that the individual active participants visually popout, as described above with reference to FIG. 6C.

In certain embodiments, visual popout can also be used to identify participants that may be about to speak or may be attempting to enter a conversation. For example, when a participant is identified as attempting to speak, the participant's window can begin to vibrate for a period of time. Once it is confirmed that the participant's activities, such as sound utterances and/or movements, correspond to actual speech or an attempt to speak, the participants window gradually stops vibrating and transitions to a highlighted window or the individual is highlighted, such as the highlighting described above with reference to FIGS. 6A-6D. FIG. 6E shows an embodiment where the participant displayed in window 104 may be attempting to speak. As a result, the window 104 vibrates while the remaining windows 102, 103, and 105-109 remain stationary. Directional arrow 610 identifies embodiments where the window 104 vibrates horizontally, and directional arrow 612 identifies embodiments where the window 104 vibrates vertically. In other embodiments, the window 104 can vibrate in other directions. When it is confirmed that the participant is speaking, the window 104 gradually stops vibrating and the window 104 or participant can be highlighted as described above with reference to FIGS. 6A-6D. On the other hand, when it is confirmed that the participant's activities do not correspond to speech, the window 104 can gradually stop vibrating. In other embodiment, rather than using vibrations to indicate that one or more participants may be about to enter a conversation, the associated window can flash or some other suitable visual popout can be employed.

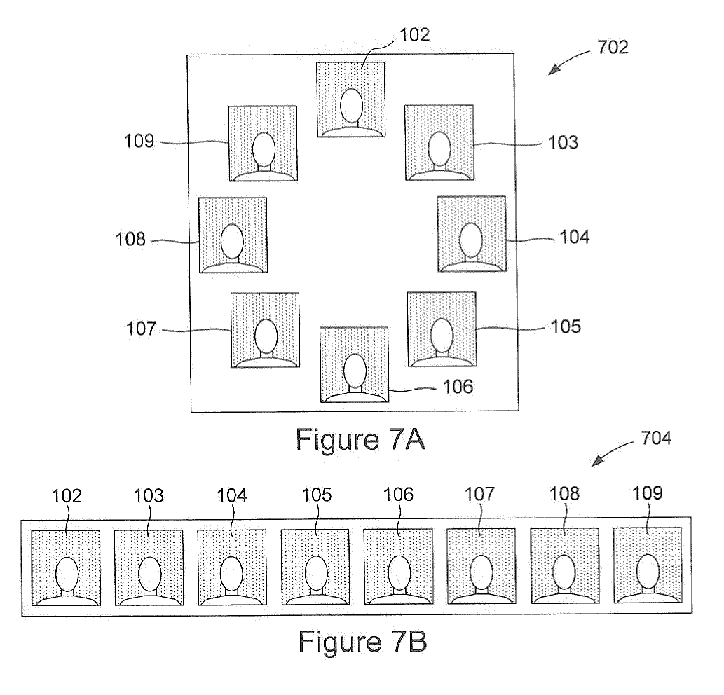

Embodiments of the present invention are not limited to displaying the windows in a two-dimensional grid-like layout as represented in user interface 100. Embodiments of the present invention include displaying the windows within a user interface in any suitable layout. For example, FIGS. 7A-7B show just two examples of many window layouts in accordance with embodiments of the present invention. In FIG. 7A, the eight windows 102-109 in user interface 702 have a substantially circular layout. In FIG. 7B, the eight windows 102-109 in user interface 704 have a linear layout. Also, embodiments of the present invention are not limited to all participants taking part in a video conference having the same window layout. For example, a first participant may select a two-dimensional grid-like layout of windows, such as the layout of user interface 100; a second participant in the same video conference may select a circular layout of the windows, such as the layout of user interface 702; and a third participant also in the same video conference may select a linear layout of windows, such as the layout of user interface 704.

Also, embodiments of the present invention are not limited to any particular number of windows. For example, embodiments of the present invention include user interfaces having as few as two windows in a point-to-point video conference to multi-point video conferences having any number of windows.

### IV. Methods for Processing Video Conferences

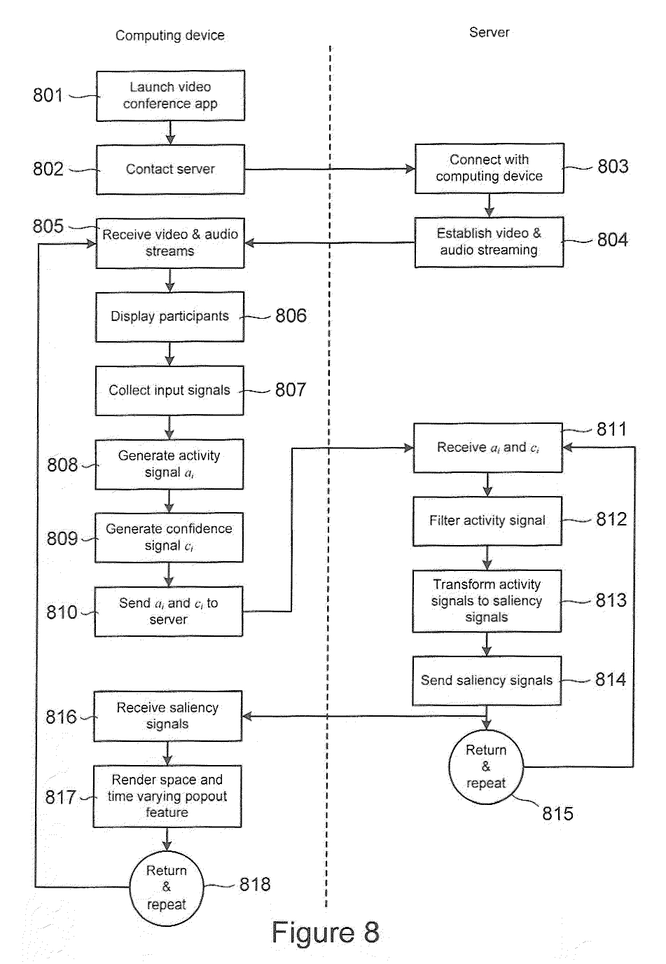

FIG. 8 shows a control-flow diagram of operations performed by a computing device and a server in conducting a video conference in accordance with embodiments of the present invention. Steps 801-818 are described with reference to the networks 200 and 300 described above with reference to FIGS. 2 and 3. In step 801, a video conferencing application stored on a computing device is launched by one or more participants. In step 802, the computing device contacts a server over a network. For example, the computing device 202 can send its internet protocol (“IP”) address to the server 204. Note that in certain embodiments, the operations performed by the server 204 can also be performed by one of the computing devices participating in the video conference, as described above with reference to FIG. 3.

In step 803, the server established a connection with the computing device over the network. In step 804, the server establishes video and audio streaming between computing devices over the network.

In step 805, the computing device receives the video and audio streams generated by the other computing devices taking part in the video conference. In step 806, the computing device generates a user interface within a display, displaying in windows the separate video streams supplied by the other computing devices taking part in the video conference, as described above with reference to the example user interfaces 100, 702, or 704. In step 807, the computing device collects input signals such as audio and video signals to be used to subsequently detect participant activity at the output of 812. The audio and video can be sounds generated by the participants and/or movements made by the participants using the computing device. For example, the sounds generated by the participants can be voices or furniture moving and the movements detected can be gestures or mouth movements. In step 808, based on the sounds and/or movements generated by the participants, the computing device processes this information and generates raw activity signals aᵢ. In step 809, the computing device also generates corresponding confidence signals cᵢ that indicate a level of certainty regarding whether or not the raw activity signals aᵢ relate to actual voices and speaking and not to incidental noises generated at the site where the computing device is located. In step 810, the activity signals aᵢ and the confidence signals cᵢ are sent to the server for processing.

In step 811, the raw activity signals aᵢ and the confidence signals cᵢ are received. In step 812, activity signals aᵢ are filtered to remove noise and gaps caused by temporary silence associated with pauses that occur during normal speech. As a result, the filtered activity signal characterizes the subjective perception of speech activity. In certain embodiments, the filtering process carried out in step 812 includes applying system identification techniques with ground truth for training. For example, “active” and “non-active” sequences of previously captured conferencing conversations can be labeled and the duration of these sequences used to set parameters of a filter that take into account the average duration of silent periods associated with pauses in natural conversational speech that does not correspond to non-activity. In other words, when someone is speaking, natural pauses or silent periods occur during their speech, but by appropriately labeling these active/non-active periods prevents naturally occurring pauses from being incorrectly identified by the filter as nonspeaking activity. This filtering process based on ground truth may be used to smooth the raw activity signals. Thus, filtered activity signals that account for natural pauses in speech and activity and have reduced audio noise are output after step 812. However, if this filtered activity signal is sent directly to a computing device in step 814, undesired attention getting visual events may occur. For example, consider a sharply varying activity signal that detects when a participant starts speaking and also when the participant stops speaking. If this activity signal is sent directly to the computing devices of other participants, as described below in step 814, the abrupt highlighting and non-highlighting of the speaking participant's window can be visually distracting for the other participants. Thus, the filtered activity signals output from step 812 are further processed in step 813 to ensure that spurious salient events do not occur. The activity signals may be further processed to express and include recent activity. For example, it may be useful to identify individuals who are dominant in a discussion, referred to as the degree of significance of a participant described below. The output signals of step 813 are called saliency signals, which are transformed activity signals that include desired properties to prevent spurious salient events in user interfaces. The saliency signals include a space varying component that identifies the window associated with the speaking participant and a time varying component that includes instructions for the length of time over which highlighting a window decays after the associated participant stops speaking in order to avoid drawing unwanted attention to the participant with a sharply varying activity signal. For example, it may be desirable to suddenly convert windows associated with participants that become active from grayscale to color, but to gradually convert the windows displaying participants that become non-active back to grayscale. The saliency signals drive the operation of the user interface of the computing device and the user interfaces of the other computing devices taking part in the video conference, as described above with reference to FIGS. 6A-6E. In step 814, the saliency signals are sent to all of the computing devices taking part in the video conference. In step 815, return and repeat steps 811-814.

In step 816, the saliency signals are received by the computing device. In step 817, the computing device renders the popout feature identified in the saliency signal. For example, the saliency signal may determine the strength of the color that is displayed for a particular window. The popout feature can be one of the popout features described above with reference to FIGS. 6A-6E. In step 818, return and repeat steps 805-817.

In other embodiments, video conferencing can be conducted by an assigned moderator that is interested in knowing which participants want to comment or ask questions. By having participants indicate their interest and having the interface subsequently distinguish active and non-active participants using popout features as described above, the moderator identifies these participants and performs the associated enabling by the moderator of a participant to have the floor.

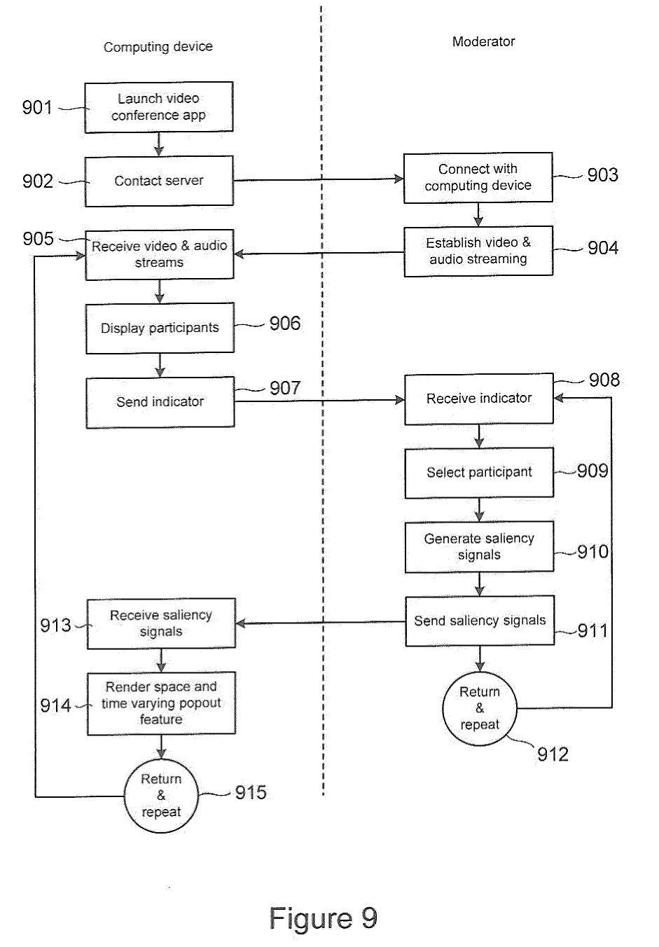

FIG. 9 shows a control-flow diagram of operations performed by a computing device and moderator conducting a video conference in accordance with embodiments of the present invention. Steps 901-913 are described with reference to the networks 200 and 300 described above with reference to FIGS. 2 and 3. In step 901, a video conferencing application stored on a computing device is launched by one or more participants located at a particular site. In step 902, the computing device contacts a computing device operated by the moderator over a network. For example, the computing device 202 can send its internet protocol (“IP”) address to the server 204 shown in FIG. 2 or to the computing device 302 shown in FIG. 3.

In step 903, the computer system operated by the moderator establishes a connection with the computing device over the network. In step 904, the computer system operated by the moderator establishes video and audio streaming between participating computing devices over the network.

In step 905, the computing device receives the video and audio streams generated by the other computing devices taking part in the video conference. In step 906, the computing device generates a user interface within a display, displaying in windows the separate video streams supplied by the other computing devices taking part in the video conference, as described above with reference to the example user interfaces 100, 702, or 704. In certain embodiments, when a participant would like to speak, the participant provides some kind of indication, such as pressing a particular button on a keyboard, clicking on a particular icon of the user interface, or making a gesture such as raising a hand. In step 907, an electronically generated indicator is sent to the computing device operated by the moderator.

In step 908, the computing device operated by moderator receives the indicator. In step 909, the moderator views a user interface with popout features, identifying which participants may want to comment or ask questions. The moderator selects a participant identified by the indicator. In step 910, saliency signals including a space varying component that identifies the window associated with the selected participant and a time varying component described above with reference to FIG. 8 is generated. The saliency signals are used to represent the active participant to the other participants. In step 911, the saliency signals are sent to all of the computing devices taking part in the video conference. In step 912, return and repeat steps 908-911.

In step 913, the saliency signals are received by the computing device. In step 914, the computing device renders the popout feature identified in the saliency signal. The popout feature can be one of the popout features described above with reference to FIGS. 6A-6E. In step 915, return and repeat steps 905-914.

Method embodiments of the present invention can also include ways of identifying those participants that contribute significantly to a video conference, called “dominant participants,” by storing a history of activity signals corresponding to the amount of time each participant speaks during the video conference. This running history of each participant's level of activity is referred to as the degree of significance of a participant. For example, methods of the present invention can maintain a factor, such as a running percentage or fraction, associated with the amount of time each participant speaks during the presentation representing the degree of significance. Based on this factor, dominant participants can be identified. Rather than fully removing the visual popout associated with a dominant participant, when the dominant participant stops speaking, embodiments can include semi-visual popout techniques for displaying each dominant participant's windows when the dominant participant stops speaking. For example, consider a video conference centered around a presentation given by one participant, where the other participants taking part in the video conference can ask questions and provide input. The presenting participant would likely be identified as a dominant participant. Method embodiments can include partially removing the highlighting associated with the dominant participant when the dominant participant is not speaking, such as reducing the luminance of the dominant participant's window or adjusting the color of the dominant participant's window to range somewhere between full color and grayscale. The popout methods described above with reference to FIGS. 8 and 9 can be used to identify the participants that ask questions or provide additional input.

Embodiments of the present invention have a number of additional advantages: (1) the popout changes in the display immediately attract a viewer's attention without requiring scanning or searching; and (2) the saliency signals generated in step 813 avoid distracting, spurious salient visual effects.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method of generating a dynamic visual representation of participants taking part in a video conference, the method comprising:
rendering an audio-visual representation of one or more participants at each site taking part in the video conference using a computing device;
receiving a saliency signal using the computing device, the saliency signal identifying the degree of current and/or recent activity of the one or more participants at each site; and
based on the saliency signal associated with each site, applying image processing to elicit visual popout of active participants associated with each site, while maintaining fixed scales and borders of the visual representation of the one or more participants at each site.

2. The method of claim 1 further comprising sending audio signals over a network between computing devices.

3. The method of claim 1 further comprising sending video signals over a network between computing devices.

4. The method of claim 1 receiving the saliency signals further comprises processing activity signals representing the audio and/or visual activities produced by the one or more participants.

5. The method of claim 1 wherein applying image processing to elicit visual popout further comprises modifying the color map of the one or more active participants.

6. The method of claim 5 wherein modifying the color map of the one or more active participants further comprises modifying the color map of the one or more active participants from color to grayscale or from grayscale to color.

7. The method of claim 1 wherein applying image processing to elicit visual popout further comprises changing the background of the visual representation of the one or more active participants.

8. The method of claim 1 wherein applying image processing to elicit visual popout further comprises creating a contrast in luminance between the one or more active participants and non-active participants.

9. The method of claim 1 wherein applying image processing to elicit visual popout further comprises vibrating the visual representation of the one or more active participants while the visual representation of non-active participants remain stationary.

10. The method of claim 1 wherein the saliency signals further comprises a time varying component directing the computing device to gradually decay the visual representation of the one or more active participants.

11. A computer readable medium having instructions encoded thereon for enabling a computer processor to perform the operations of claim 1.

12. A method for identifying participants active in a video conference, the method comprising:
receiving activity signals generated by one or more participants, the activity signals representing audio-visual activities of the one or more participants;
removing noise from the activity signals using the computing device;
transforming the activity signals into saliency signals using the computing device; and
sending saliency signals from the computing device to other computing devices operated by participants taking part in the video conference, the saliency signals directing the computing devices operated by the participants to visually popout the one or more active participants.

13. The method of claim 12 further comprising optionally storing a history of activity signals associated with each participant in a computer readable medium in order to determine each participants associated degree of significance in the video conference.

14. The method of claim 12 further comprising receiving confidence signals indicating a level of certainty regarding whether or not the activity signals represent audio-visual activities of the one or more participants.

15. The method of claim 12 wherein removing noise from the activity signals further comprises removing noise from the audio signals and from the video signals.

16. The method of claim 12 wherein sending the saliency signals from the computing device to other computing devices further comprises sending the saliency signals over a network.

17. The method of claim 15 wherein the network further comprises at least one of: the Internet, a local-area network, an intranet, a wide-area network, a wireless network, or any other suitable network allowing computing devices to computing devices to send and receive audio and video signals.

18. The method of claim 12 wherein the saliency signals directing the other computing devices to render visually salient the window further comprises directing the other computing devices to render using visual popout representations of participants for a period of time before decaying.

19. The method of claim 1 wherein the saliency signals directing the computing devices operated by the participants to visually popout the one or more active participants further comprises at least one of:
modifying the color map associated with one or more participants,
modifying the color map associated with one or more participants from color to grayscale or from grayscale to color,
changing the background associated with one or more particpants,
creating a contrast in luminance between active and non-active participants, and
vibrating the window holding one or more active participants while windows displaying non-active participants remain stationary.

20. A computer readable medium having instructions encoded thereon for enabling a computer processor to perform the operations of claim 12.
